(19) United States
(12) Patent Application Publication
(10) Pub. No.: US 2016/0368023 A1
(43) Pub. Date: Dec. 22, 2016

(54) SCREENING SYSTEM

(71) Applicant: assonic Mechatronics GmbH, Radevormwald (DE)

(72) Inventors: Rüdiger TÜSHAUS, Dorsten (DE); Stefan BEIDATSCH, Radevormwald (DE)

(73) Assignee: assonic Mechatronics GmbH, Radevormwald (DE)

(21) Appl. No.: 15/185,215

(22) Filed: Jun. 17, 2016

(30) Foreign Application Priority Data
Jun. 18, 2015 (DE) 102015109730.3
Aug. 25, 2015 (DE) 102015114076.4

(51) Int. Cl. B07B 1/28

(52) U.S. Cl. CPC B07B 1/28; B07B 2201/04

(57) ABSTRACT

A screening system includes a first vibration generator, an excitation frame which is connected to the first vibration generator, and an excitation support screen which is connected to the excitation frame and includes first screen openings. A change screen held in a change frame has second screen openings of a size which is smaller than a size of the first screen openings. The change screen is arranged detachably from the excitation support screen and placed atop the excitation support screen, when assembled.

### CROSS-REFERENCES TO RELATED APPLICATIONS

This application claims the priority of German Patent Applications, Serial No. 10 2015 109 730.3, filed Jun. 18, 2015, and Serial No. 10 2015 114 076.4, filed Aug. 25, 2015, pursuant to 35 U.S.C. 119(a)-(d), the disclosures of which are incorporated herein by reference in their entireties as if fully set forth herein.

### BACKGROUND OF THE INVENTION

The present invention relates to a screening system.

The following discussion of related art is provided to assist the reader in understanding the advantages of the invention, and is not to be construed as an admission that this related art is prior art to this invention.

It has been known in flat screens to use ultrasound excitation of a screen fabric that is stretched in a screen frame. While this may be sound in unclogging the screen fabric, repair work is expensive and time-consuming, when the screen fabric becomes damaged. In this case, the entire screen structure, including the ultrasound converter has to be dismantled because of the connection of the ultrasound converter with the screen.

It would therefore be desirable and advantageous to provide an improved screening system to obviate prior art shortcomings and to minimize repair costs.

### SUMMARY OF THE INVENTION

According to one aspect of the present invention, a screening system includes a first vibration generator, an excitation frame connected to the first vibration generator, an excitation support screen connected to the excitation frame and including first screen openings, a change frame, and a change screen held in the change frame and having second screen openings of a size which is smaller than a size of the first screen openings, the change screen being arranged detachably from the excitation support screen and placed atop the excitation support screen, when assembled.

The present invention resolves prior art shortcomings by separating the vibration generator from the change screen. The change screen may hereby involve a fiat screen primarily oriented in horizontal arrangement. The presence of the excitation support screen fulfills hereby two functions: Firstly, the transmission of vibrations from the excitation support screen to the change screen. Secondly the excitation support screen with its greater screen openings supports the change screen.

According to another advantageous feature of the present invention, the excitation support screen can have a single-piece configuration, i.e. a monolithic structure. As an alternative, the excitation support screen may be made of multiple parts, such as, e.g., wires, which can be advantageously joined to one another by a material joint, e.g. sintered. The excitation support screen may advantageously involve a single-layer sintered fabric. It may also involve a perforated metal sheet, or etched metal sheet, or stretched lattice. As an alternative, the excitation support screen may involve a typical (non-sintered) screen fabric. The excitation support screen can be metallic, e.g. of special steel or aluminum, or an aluminum alloy, and should have a large throughput area which should range from 30% to 90%. Advantageously, the throughput area should be 50%. Currently preferred is a throughput area in a range of 60% to 80%.

The excitation support screen is connected with the excitation frame which thus secures the excitation support screen. The excitation frame may be realized as welded structure or a structural part which is trimmed to size, e.g. by laser cutting. The excitation frame carries the excitation support screen and assumes the function of vibration transmission onto the excitation support screen. The connection between the excitation frame and the excitation support screen can be advantageously realized by material joint, in particular sintered, or via a bonded connection. Ultrasound is introduced into the excitation frame by the vibration generator, also called vibration converter or short converter.

The change frame may be made of metal or appropriate plastic.

According to another advantageous feature of the present invention, the vibration generator can operate at a frequency of 30 to 38 kHz and be connected for transmission of vibrations to the excitation frame.

A screening system according to the present invention is characterized by the absence of any pretension on the change screen in the screen plane, i.e. in horizontal direction, since the change screen is supported by the excitation support screen. The change screen can therefore be held in the frame in substantially stress-free manner and is therefore exposed to significantly less stress when compared with a conventional screen that is stretched in a frame. Moreover, the excitation support screen can be best suited to the change screen and to absorb loads applied on the change screen by the material being screened so that the change screen does not sag to any appreciable extent. Thus, the change screen is not exposed to additional stress during screening operation that could otherwise shorten the service life of the change screen.

A benefit of a change screen in combination with a separate excitation support screen is the capability to remove the change screen, when damaged, independently from the excitation support screen and the vibration generator, and to replace it with another change screen. Repair works are much faster, as fewer components are required to be dismantled. Disassembly and assembly is simpler and production waste is decreased. As the change screen can easily be replaced, any change in specification can also realized in a fast and simple manner. A user is presented with high flexibility in terms of screen specification.

A further benefit of the presence of the excitation support screen is that small damage in the change screen is prevented from suddenly becoming a tear which could be experienced in conventional screens without such support. In any event, risk of failure is significantly reduced.

The change screen is held substantially stress-free on the change frame. The term “substantially stress-free” is hereby to be understood as the absence of a targeted pretension within the screen plane upon the change screen. The change frame is self-supporting and rigid enough so as not to deform and not to introduce additional tensile forces into the change screen. Unlike conventional screen frames, bending strength of the change frame is hereby used to enable the change screen to be installed as stress-free as possible and not to absorb stress of a pretensioned or stretched screen.

According to another advantageous feature of the present invention, the change frame can be configured for detachably coupling with the excitation frame. In this way, the change screen in its entirety can be detachably coupled with the excitation frame. The connection can be realized by screw connections or plug connections or clamped connections. Clamped connections involve, e.g. quick clamping elements (clamping claws) which push the change frame from atop against the excitation frame and may expose the change frame to stress which, however, is negligible so that the change screen overall is still substantially stress-free.

The vibration generator in the form of an ultrasound exciter is advantageously located outside of a screening housing. The vibration generator is connected to the excitation frame to transmit vibrations thereto. This may be realized via a sound conductor. The sound conductor may be arranged within the screen housing. This enables maintenance, repair, or also exchange of the vibration generator without intervention into the screen housing. The sound conductor may be connected to the excitation frame from above, from the side of the change screen, or also from below.

Transmission of ultrasound vibrations is sufficient to greatly reduce adhesive forces and frictional forces between screening material and screen or in the screening material itself.

According to another advantageous feature of the present invention, provision may be made for a further vibration generator which is connected to the excitation frame and operates at a frequency of 30 to 1000 Hz. The further vibration generator may involve a pneumatic hammer which supplements the ultrasound vibrations with smaller frequencies. Even though, there may be a possibility that in an arrangement with loosely placed screen, screening material may migrate between the excitation support screen and the change screen, this occurrence does not impair screening output or cause added stress. Still, the provision of the further vibration generator operating at a lower frequency (30 to 1000 Hz) and especially at a greater amplitude than the first vibration generator, especially when configured as pneumatic hammer, enables the excitation support screen to oscillate against the change screen. This, in turn, improves screening effect of the change screen. The vibration generator may act for this function upon the screen frame from above, from the side, or from below.

The provision of such a pneumatic hammer or low-frequency vibration generator (also excited electrically) is not necessarily required, when the screening system involves an oscillating screen of vibratory screen in which the entire screening assembly is oscillatingly suspended and excited. Vibrations, emanating from such a screening machine are intense enough to render the presence of an additional low-frequency vibration generator generally unnecessary. A low-frequency vibration generator may be excited not only pneumatically but also electrically for example.

The present invention involves screening systems for installation situations in which a surrounding housing does not transmit additional vibrations upon the screening system. In this case, provision can be made for an ultrasound oscillator and in addition for a low-frequency oscillator.

The present invention also involves screening systems for use in screening machines. Screening machines include their own vibration generating mechanism. The frequencies in such screening machines are normally of low frequency. When using screening systems in such screening machines, the provision of an additional ultrasound oscillator is beneficial, with ultrasound and low-frequency vibration supplementing each other. Thus, low-frequency vibration generators are not necessarily required, when the screening machines involve oscillating screens or vibratory screens in which the entire screening assembly is oscillatingly suspended and excited. Vibrations, emanating from such a screening machine, are intense enough to render the presence of an additional low-frequency vibration generator generally unnecessary, but still may be additionally provided.

Such low-frequency vibration generators can be easily arranged in the flow of material being screened, i.e. they may be located above the screen or also below the screen. In contrast thereto, ultrasound converters have to be protected from contaminations. Like in a pneumatic hammer, ultrasound may be introduced from above or from below into the excitation support screen. Advantageously, the sound conductor is threadably engaged with the excitation frame. When routing the sound conductor from above, the change screen is provided with an appropriate opening. Seals can be used to ensure adequate tightness within the screen plane.

To prevent damage to the change screen as a result of unevenness of the excitation support screen, the excitation support screen can be calendered. In this way, any spot-shaped elevations in the fabric can be evened out. Concentrated stress to the fine-mesh change screen is thus avoided. In addition, excitation of the change screen and the screening material is more uniform.

A screening system according to the present invention provides beneficial results also because the weight force of the screening material urges the change screen against the excitation support screen. As a result, there is no need to stretch the change screen in the screening system according to the invention. Excitation of the excitation support screen through ultrasound is transmitted to the change screen in a superior manner by the multiple contacts between change screen and excitation support screen, thereby realizing superior screening results, without any need to stretch the change screen in any way or to expose it to intense stress.

The benefits as a result of significantly simpler repair greatly outweigh any benefit that may arise in terms of possibly slightly better screening results under certain operating, when stretching of a screen is involved.

An advantage of a screening system according to the invention resides in the simplicity to replace the screen with a screen having different openings or for screening other materials. This provides great flexibility and a wide range of applications of a screening system according to the invention.

The excitation frame can be best suited to the screening machine. The change screen may, e.g., be round or also square or rectangular. Accordingly, the contours of the excitation frame and also of the change frame are suited to one another. According to another advantageous feature of the present invention, the excitation frame can include a circumferential edge member, a center piece, and struts connecting the center piece with the edge member. The low-frequency vibration generator can hereby be operably connected with the center piece. In other words, one vibration generator, in particular a pneumatic hammer, is connected directly with the center piece. The central introduction of the low-frequency vibration enables the excitation support screen to vibrate substantially even against the change frame. Ultrasound vibrations transmit well to the excitation support screen as a result of the connection of the excitation support screen by material joint, even in the presence of an eccentric introduction into the excitation frame. Thus, the vibration generator of high frequency may be operatively connected with an eccentrically arranged strut.

The change screen has a mesh width of 20 μm to 2,000 μm. Currently preferred is a mesh width in a range of 20 μm to 200 μm. The wire thickness of the change screen at a mesh width of 20 μm is also 20 μm and increases to 500 μm at a mesh width of 2,000 μm.

Additional cleaning elements, e.g. spheres, may be arranged underneath the excitation support screen. These spheres may, be caused to vibrate and act like a hammer from below against the excitation support screen and thus also against the change screen.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective exploded view of a first embodiment of a screening system according to the present invention;

FIG. 2 is an exploded view of the screening system of FIG. 1 with mounted vibration generators;

FIG. 3 is a perspective exploded view of a second embodiment of a screening system according to the present invention;

FIG. 4 is an exploded view of the screening system of FIG. 3 with mounted vibration generators;

FIG. 5 is a perspective view of the screening system of FIG. 2 in an assembled state;

FIG. 6 is a perspective view of the screening system of FIG. 4 in an assembled state;

FIG. 7 is a cutaway view of the screening system of FIG. 5; and

FIG. 8 is an enlarged detailed view of the marginal region of the screening system of FIG. 5.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

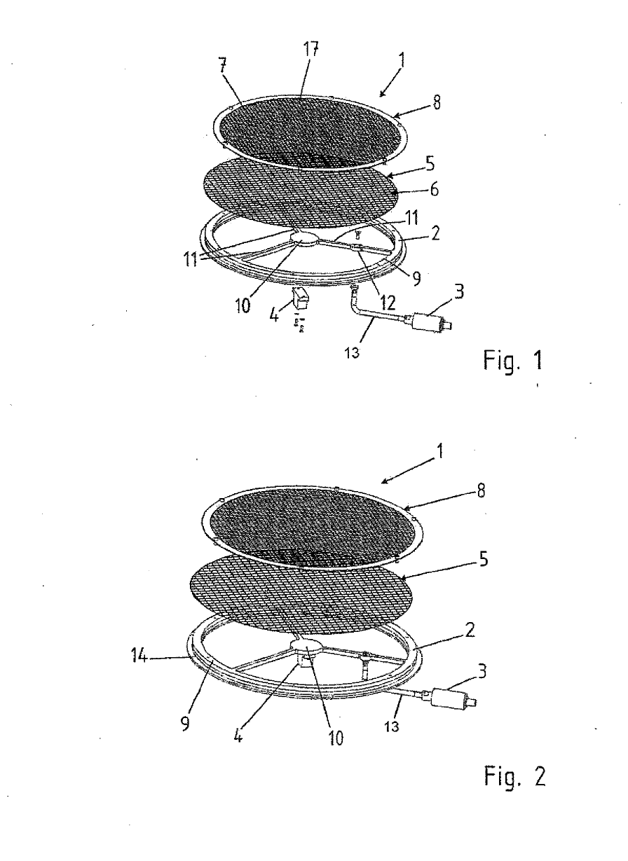

Turning now to the drawing, and in particular to FIG. 1, there is shown an exploded view of a first embodiment of a screening system according to the present invention, generally designated by reference numeral 1 and involving a flat screen. Material being screened is applied from above upon the flat screen, when installed, with fines falling through, whereas oversized particles are diverted in a manner not shown in greater detail.

The screening system 1 includes an excitation frame 2 and two vibration generators 3, 4 which are connected with the excitation frame 2 as shown in FIG. 2. Arranged atop the excitation frame 2 is an excitation support screen 5 having screening openings 6. A change screen 7 is located above the excitation support screen 5 and secured to a change frame 8. The change screen 7 is a structure that is separate from the excitation support screen 5 and has screening openings 17 of a size which is smaller than a size of the screening openings 6 of the excitation support screen 5. In the assembled state, both the excitation support screen 5 and the change screen 7 touch one another. The excitation support screen 5 supports the change screen 7 and, in turn, rests upon the excitation frame 2.

In the non-limiting example, shown in FIG. 1, the excitation frame 2 has a round configuration. Correspondingly, also the excitation support screen 5 and the change screen 7, placed atop the excitation support screen 5, with the change frame 8 has a round configuration. The excitation frame 2 includes a circumferential edge member 9, a center piece 10, and several struts 11 which connect the center piece 10 with the edge member 9. A receiving opening 12 is provided approximately at half the length of one of the struts 11 to enable connection of an L-shaped sound conductor 13 with the one strut 11 and thus with the excitation frame 2. The sound conductor 13 is connected with a first vibration generator 3 which operates at a frequency range of 30 to 38 kHz. The first vibration generator 3 is situated outside of the circular or cylindrical region defined by the change frame 8 and the excitation frame 2. When assembled, the vibration generator 3 is located outside a screen housing.

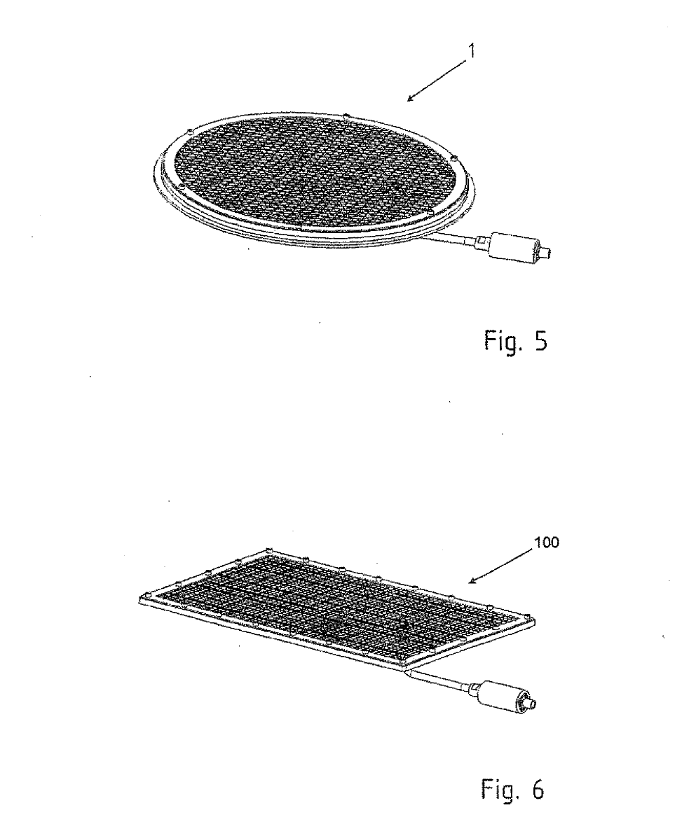

The second vibration generator 4 operates at a frequency of 30 to 1000 Hz and may be designated as a hammer, which can be operated with compressed air or electrically. The vibration generator 4 is positioned centrally underneath the center piece 10 and threadably engaged thereto, as shown in FIG. 2. Six screw fasteners 14 are dispersed about the circumference of the edge member 9 of the excitation frame 2 for threaded connection of the change frame 8 and the change screen 7 to the excitation frame 2, with the excitation support screen 5 being incorporated therein for transmission of vibrations and with incorporation of suitable border-side seals. FIG. 5 shows the screening system 1 in fully assembled state.

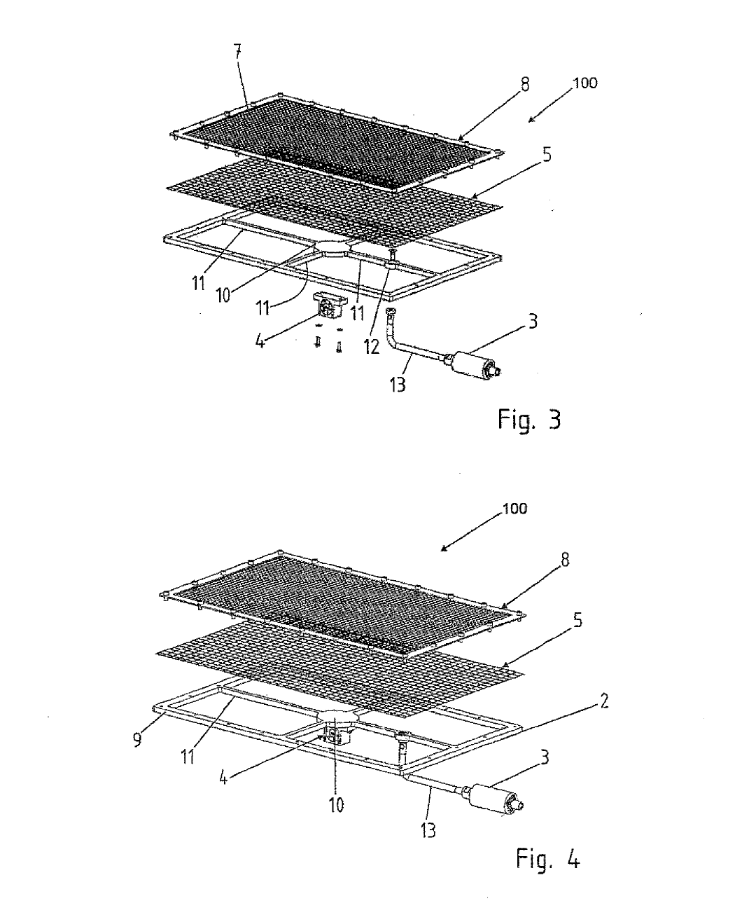

FIG. 3 is a perspective exploded view of a second embodiment of a screening system according to the present invention, generally designated by reference numeral 100. Parts corresponding with those in FIG. 1 are denoted by identical reference numerals and not explained again. The description below will center on the differences between the embodiments. In this embodiment, the screening system 100 has a rectangular configuration. The excitation frame 2 is also excited in the screening system 100 by a vibration generator 3 with ultrasound vibrations. A vibration generator 4 is located underneath the center piece 10 and held in place by the struts 11 (FIG. 4). The screening system 100 includes four struts 11 which extend from the center piece 10 to midsection of the sides of the rectangular excitation frame 2. Opposing struts 1 have a same length. One of the struts 11 is again provided with a receiving opening 12 for passage of a sound conductor 13 which transmits ultrasound vibration from the vibration generator 3 into the excitation frame 2. The excitation support screen 5 is bonded to the excitation frame 2 in a manner not shown in greater detail. Placed atop the excitation support screen 5 is the change screen 7 which is held in a change frame 8. The excitation frame 2 with the excitation support screen 5 is threadably connected, like in the screening system 1 of FIGS. 1 and 2, by screw fasteners 14 with the change frame 8. The fully assembled screening system 100 is shown in FIG. 6.

FIG. 7 is a cutaway view of the screening system 1, as shown in FIG. 5 As is readily apparent, both the change screen 7 and the excitation support screen 5 are situated between the change frame 8 and the excitation frame 2. The screw fasteners 14 push hereby the change frame 8 from atop against the excitation frame 2.

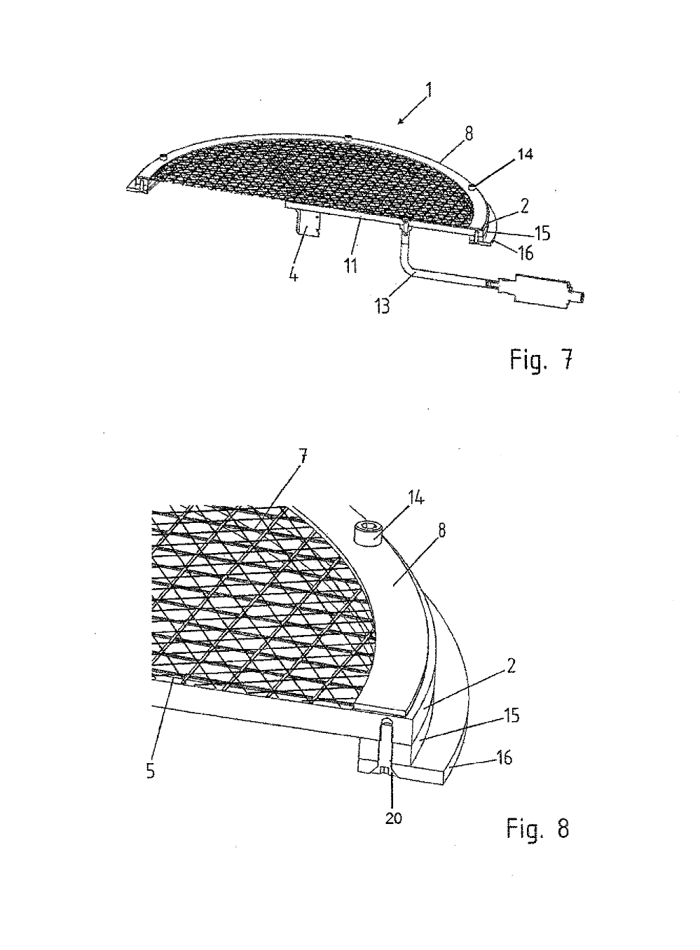

FIG. 8 is an enlarged detailed view of a marginal region of the screening system 1 and shows the arrangement of a distance frame 15 underneath the excitation frame 2. A mounting ring 16 is connected to the distance frame 15 and has an outer circumference which is greater than an outer circumference of the distance frame 15. Both the distance frame 15 and the mounting ring 16 are provided to conform the screening system 1 to the installation situation at hand and are threadably connected with the excitation frame 2 by screw fasteners 20. Optionally, a damping ring (not shown) may be placed between the distance frame 15 and the excitation frame 2 to prevent transmission of vibrations into the machine frame.

Common to all embodiments is the stress-free support of the change screen 7 in the change frame 8 and the detachable securement of the change screen 7 via screw fasteners 14 to the change frame 8 so that the change screen 7 rests on the excitation frame 2 and can easily be replaced, if need be, e.g. when the screen openings 17 of the change screen 7 become damaged, or when screen specification demands an exchange of the change screen 7 and change frame 8. There is no need to dismantle the excitation support screen 5 with the excitation frame 2.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A screening system, comprising:
a first vibration generator;
an excitation frame connected to the first vibration generator;
an excitation support screen connected to the excitation frame and including first screen openings;
a change frame; and
a change screen held in the change frame and having second screen openings of a size which is smaller than a size of the first screen openings, said change screen being arranged detachably from the excitation support screen and placed atop the excitation support screen, when assembled.

2. The screening system of claim 1, wherein the change screen is held substantially without stress in the change frame.

3. The screening system of claim 1, wherein the change frame is configured for detachably coupling with the excitation frame.

4. The screening system of claim 1, wherein the first vibration generator operates at a frequency of 30 to 38 kHz and is connected for transmission of vibrations to the excitation frame.

5. The screening system of claim 1, further comprising a second vibration generator connected to the excitation frame and operating at a frequency of 30 to 1000 Hz.

6. The screening system of claim 1, wherein the excitation frame includes a circumferential edge member, a center piece, and struts connecting the center piece with the edge member.

7. The screening system of claim 6, further comprising a second vibration generator connected to the excitation frame, wherein one of the first and second vibration generators operates at a lower frequency and is operably connected with the center piece.

8. The screening system of claim 7, wherein the other one of the first and second vibration generators operates at a higher frequency and is operably connected with one of the struts.

9. The screening system of claim 1, wherein the excitation support screen is connected by a material joint with the excitation frame.

10. The screening system of claim 1, wherein the excitation support screen is calendered.

11. The screening system of claim 1, wherein the change screen is pressed against the excitation support screen in a region of the change frame, and pressed in remaining regions by its own weight and material to be screened against the excitation support screen.

12. The screening system of claim 1, wherein the excitation support screen has a single-piece configuration.

13. The screening system of claim 1, wherein the excitation support screen is made of multiple parts joined to one another by a material joint.
